(19) United States
(12) Patent Application Publication
(10) Pub. No.: US 2014/0222476 A1
(43) Pub. Date: Aug. 7, 2014

(54) Anomaly Detection in Interaction Data

(71) Applicant: VERINT SYSTEMS LTD., Herzilya Pituach (IL)

(72) Inventor: Roni Romano, Even Yehuda (IL)

(73) Assignee: VERINT SYSTEMS LTD., Herzilya Pituach (IL)

(21) Appl. No.: 14/173,437

(22) Filed: Feb. 5, 2014

Related U.S. Application Data
(60) Provisional application No. 61/761,476, filed on Feb. 6, 2013.

(51) Int. Cl. G06Q 10/06; G06Q 30/00

(52) U.S. Cl. CPC G06Q 10/063; G06Q 30/016
USPC 705/7.11

(57) ABSTRACT

Method of automated anomaly detection includes obtaining a corpus of interaction data. Regular interaction data is identified from the corpus of interaction data with a processor. New interaction data is received. The processor compares the new interaction data to the identified regular interaction data The processor identities anomalies in the new interaction data.

### CROSS-REFERENCE TO RELATED APPLICATIONS

The present application claims priority of U.S. Provisional Patent Application No. 61/761,476, filed on Feb. 6, 2013 the contents of which are hereby incorporated herein by reference in their entirety.

### BACKGROUND

The present disclosure is related to the field of data processing. More specifically, the present disclosure is related to the automated detection of anomalies or rare events in interaction data.

Modem interaction systems, including those used for customer service interactions, exemplarily in the telecom business, are capable of gathering large amounts of interaction data. The interaction data may include transcripts of spoken interpersonal interactions as well as include the obtained data regarding participants in the interaction. The interaction data may also include transcripts of interactions that occur in other communication platforms, including email, web chat, and social media. The interaction data may also include other forms of data such as customer survey responses and user entered data into a computer system.

This vast amount of interaction data requires new tools and processes for identifying irregular behaviors or occurrences in newly obtained interaction data.

### BRIEF DISCLOSURE

A method of automated anomaly detection includes obtaining a corpus of interaction data at a computer readable medium. Regular interaction data is identified from the corpus. New interaction data is received at a processor. The new interaction data is compared with the processor to the identified regular interaction data. Anomalies in the new interaction data are identified with the processor.

Exemplary embodiments of a method of automated anomaly detection include obtaining a corpus of interaction data. Regular interaction data is identified with a processor from the corpus by identifying a plurality of attributes in the corpus of interaction data. An associated distribution of values for each of the identified plurality of attributes is identified. New interaction data is received at the processor. The plurality of attributes are identified in the new interaction data. Values are identified for each of the identified attributes. The attribute values from the new interaction data are compared to the associated distribution of values for each of the plurality of attributes. Based upon the comparison, anomalies in the new interaction data are identified with the processor.

In a still further exemplarily embodiment of a method of automated anomaly detection, a corpus of interaction data is obtained. The interaction data includes a plurality of attribute values. Regular interaction data is identified from the corpus by taking a subset of the corpus and labeling the attribute values of the subset as regular interaction data. A random corpus is generated that includes a plurality of attribute random values. The purity of attribute random values are labeled as irregular interaction data. At least one regular attribute pattern is derived and at least one anomaly attribute pattern is derived from the regular interaction data and the irregular interaction data. New interaction data is received. The new interaction data is compared to the at least one regular attribute pattern and the at least one anomaly attribute pattern. Anomalies in the new interaction data are identified.

### BRIEF DESCRIPTION OF THE DRAWINGS

FIG. 1 is a schematic diagram that depicts an exemplary embodiment of anomaly detection.

FIG. 2 is a flow chart that depicts an exemplary embodiment of a method of anomaly detection.

FIG. 3 is a flowchart that depicts an exemplary generalized embodiment of a method of anomaly detection.

FIG. 4 is a system diagram of an exemplary embodiment of a system for anomaly detection.

### DETAILED DISCLOSURE

As used herein, an anomaly refers to an occurrence that is unusual to a regular or expected course or progression of attribute data values in interaction data, exemplarily customer service interaction data.

The present disclosure uses the example of a recorded customer service interaction that is typically conducted over the phone between a customer and a customer service agent. While this example is used throughout the present disclosure, the example is not intended to be limiting on the scope of the interaction data to which the disclosed processes may be applied or other use thereof. Other embodiments may use customer service interaction data from interactions solely between a user and a computer system. An alternative application may exemplarily be analysis of customs border crossing information entered/received by a person seeking admittance into a country. Similarly, while the present disclosure uses the example of a customer service interaction that is recorded and then transcribed, similar embodiments within the scope of the disclosure may include the analysis of the audio files themselves, streaming audio, real-time transcription, or analysis of video data.

Turning now to the example of a customer service interaction, over the course of institutional experience and/or analysis of a large number of customer service interactions, certain patterns may develop over time in characteristics of the customer service interactions related to customer information (e.g. gender, age, location, income), actions (e.g. bill payment, billing dispute, add service, cancel service, warranty claim) and the product (e.g. device, service, subscription, content). As disclosed in more detail herein, automated detection of customer service interactions that do not match these common patterns may represent anomalies or rare events in the body of all the customer service interactions and identification of these anomalies can be leveraged to provide early detection of emerging topics or trends or can be used internally to improve the quality of other data analysis system or processes related to the customer service interaction.

In a non-limiting example a customer service interaction may occur when a customer calls a customer service telephone number and interacts with a customer service agent. The audio data of the customer service interaction may be recorded or streamed and this audio data may be transcribed exemplarily through speech-to-text technology. The transcribed customer service interaction can be combined with other customer data stored in a customer service database or other information such as customer data collected and/or entered by the customer service agent, received emails, web chats, or survey responses received from the customer. All of this information may be collectively referred to herein as customer service data.

As non-limiting examples, a customer service interaction may typically have an identified purpose and a resulting pattern may be identified for the customer service interaction based upon such a purpose. As a non-limiting example, a customer calling regarding a complaint that the cost of long distance telephone calls are too expensive may be a relatively common customer service interaction received by a telephone service provider and the customer service interaction includes data and a pattern that is common or to be expected. In another customer service interaction, exemplarily after the release of a new product, the questions or complaints received during the customer service interaction may be previously unreceived and this may be characterized as an anomaly.

In a still further example of an anomaly, as customer service interaction may include the identification of a customer who is unusually young for the identified product or service. Such an example may be that of a customer identified as being 14 years old calling regarding a cell phone service contract. In an embodiment, this may be identified as a deviation from normal customer service interactions as normally the customers of the cell phone service are typically 18 years old or older. Once this anomaly is detected, the anomaly can he analyzed in order to determine whether the occurrence is in fact an anomaly or is a result of other internal data processing including, but not limited to errors in the speech-to-text transcription of the customer service interaction. In as non-limiting example, the 14 year old customer may in fact be identified as their age being 40 years old and the speech-to-text transcription produced an error that transcribed “forty” as “fourteen”. Alternatively, the anomaly may be an indication of an emerging trend that will require. further action in the management of future customer service interactions. In this example, the identified 14 year old customer anomaly may be the beginning of an emerging trend of younger customers of the company's products or services, which may require a review or further steps of customer service interaction procedures adequately to a younger set of new customers.

In some embodiments, the interpretation of the identified anomaly may be performed in connection to the other customer service interaction data in an effort to distinguish between emerging trends and transcription error. As a non-limiting example with the identified 14 year old customer, if the customer service interaction was a call to register a complaint regarding a small size of a cell phone, then such a complaint by a 14 year old may be identified as being highly unlikely, and it would be a far more common occurrence for a 40 year old to complain about the size of a phone rather than a 14 year old.

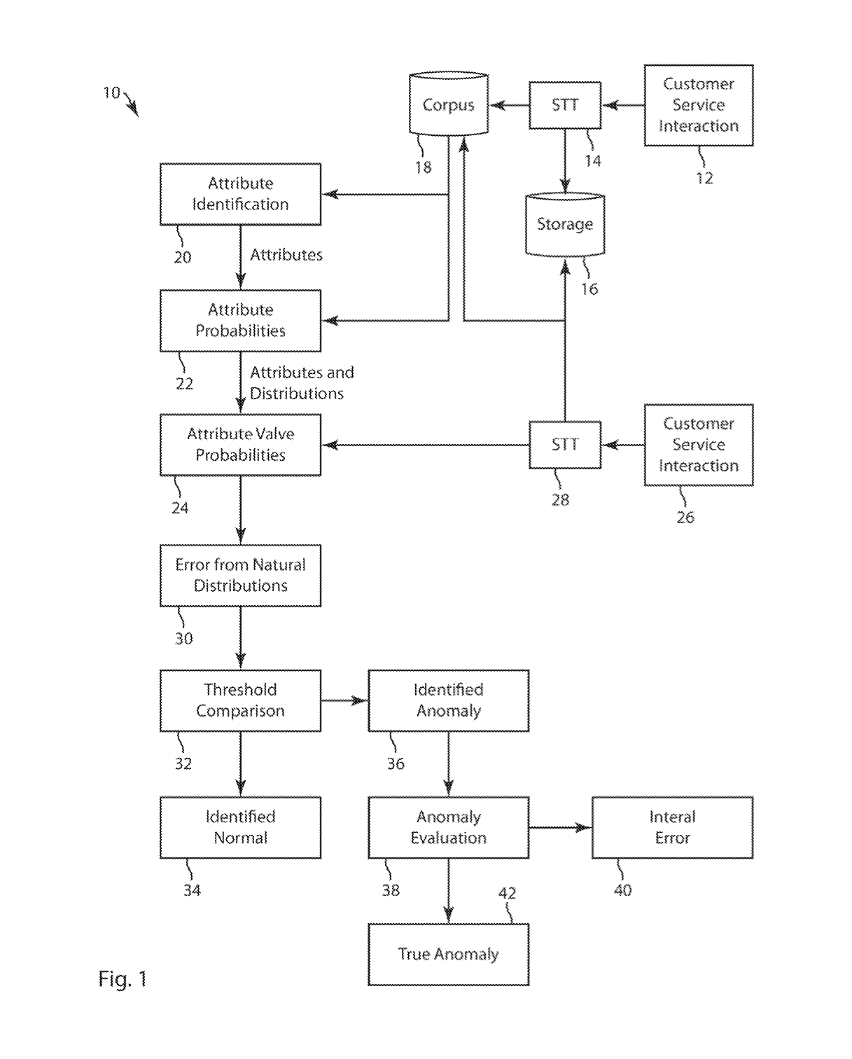

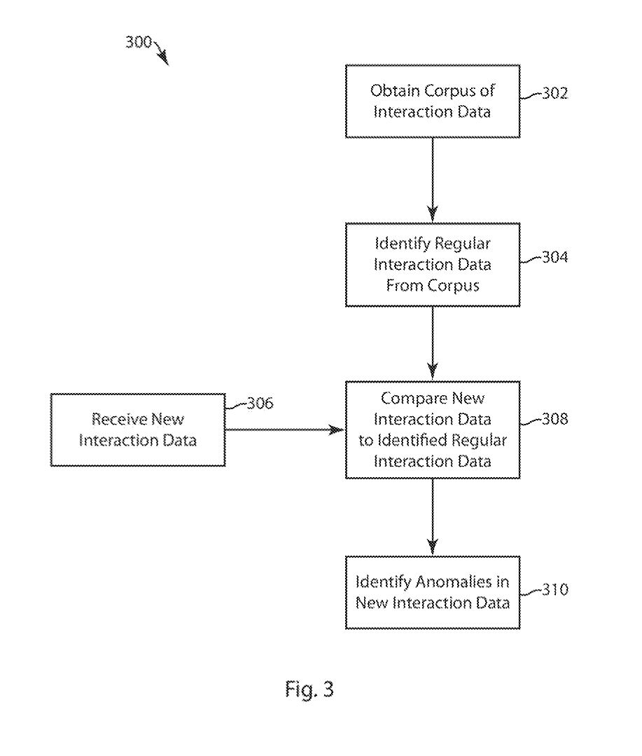

FIG. 3 is a flow chart that depicts an exemplary generalized embodiment of a method 300 of anomaly detection. A person of ordinary skill in the art will understand further details of the method 300 in view of the detailed descriptions of more specific embodiments as disclosed with respect to FIGS. 1 and 3 and in further view of the description of FIG. 3 as found herein.

The method 300 is directed to the detections of anomalies in interaction data. This interaction data may be acquired from any of the variety of sources, including, but not limited to customer service interactions and interactions between a user and a computer system whereby data from the user is collected from said interactions. At 302 a corpus of interaction data is obtained. Exemplarily, the corpus is a large set of interaction data that may include diverse data types and may be acquired from a wide variety of interaction data sources as will be described in further detail herein.

Next, at 304 regular interaction data is identified from the corpus. In an exemplary embodiment as disclosed in further detail herein, the regular interaction data may be identified by calculating a distribution of values found in different attributes of the interaction data. In an alternative exemplary embodiment, the corpus as a whole is considered to represent regular interaction data and patterns within the corpus may be identified to reflect this regular interaction data. It will be noted that in these exemplary embodiments, the identification of the regular interaction data, 304 in part comes from taking, the corpus as a whole, or a large portion of the corpus in combination with an assumption that even a large interaction data set, that the corpus as a whole reflect regular or expected data occurrences.

At 306 new interaction data is received. This new interaction data may exemplarily be produced as a result of a customer service interaction of may be another type of interaction, exemplarily between a user and a computer system that is to be processed for anomaly detection. At 308 the new interaction data received at 306 is compared to the regular interaction data identified at 304. This comparison may exemplarily be on an attribute by attribute basis Or may alternatively seek to determine whether the received new interaction data lies within identified patterns in the regular interaction data.

As a result of the comparison at 308 anomalies in the new interaction data can be identified at 310. Various action that may be taken in response to the detection of an anomaly in the new interaction data will be described in further detail herein. Exemplary embodiments of identifications of anomalies and responsive action may include producing alerts or flags of the identified anomalies, or diverting the new interaction data for further evaluation and analysis in order to determine a cause of the anomaly.

Referring now to FIG. 1, FIG. 1 is a schematic diagram of a non-limiting embodiment of a process 10 to identify anomalies such as in customer service interaction data. The process 10 represents an exemplary more detailed application of the method 300 described above. According, to the system 10, a plurality of customer service interactions 12. are recorded and transcribed such as through. speech to text algorithms, processes, or services 14. The transcribed customer service interactions are stored at 16. It is to be recognized that the customer service interaction data stored at 16 may also include further customer data, or interaction data, related to the customer service interaction, which such customer service interaction data may include other customer data stored. in a customer database or linked to a customer account, other customer communications (whether audio, email, web chat, etc.), or survey responses provided by the customer.

The customer service interaction data is used to provide the corpus 18 or pool of customer service. interaction data that is used to automatedly identify anomalies. In a non-limiting embodiment, the corpus may exemplarily be a data set of one million sets of customer service interaction data. Each set of customer service interaction data may break the customer service interaction into discrete data values that represent a vast array of information regarding the customer service interaction. While the actual number of such data values may be limitless, a merely exemplary and non-limiting list of some such data values may include customer data (e.g. sex, age, location, income, survey responses, product purchases, returns, or warranty claims, customer length or longevity, products/service information (e.g. product/service identification purchase, renewal, survey results, related or add on products/services, warranty information, recall information, and actions or purposes (e.g. complaints, questions, add service, cancel service, warranty claim, product/service purchases, billing disputes, billing payments).

The corpus 8 includes all of the customer service interaction data broken out into data values. This corpus is processed in order to identify the most important attributes or value categories for the identification of anomalies in customer service interaction at 20. Exemplarily, because of the effectively, or nearly, unlimited number of potential values in the corpus, a small number representative of the most important values for anomaly detection must be identified. In a non-limiting example, a number between five and ten attributes are identified such as to provide a vector of attributes that can reasonably be processed. However, one of ordinary skill in the art will recognize that other numbers of attributes may be used to define such a vector. In one embodiment, the attributes are identified at 20 based upon a minimum information gain criteria. Non-limiting examples may include decision trees derived according to the C4.5 or J48 algorithms; however, it will be understood that other techniques may be used in alternative embodiments.

As an exemplary embodiment, the algorithm used may rely upon the concept of information entropy. The algorithm builds a decision tree wherein each node of the tree selects an attribute of data that most effectively splits the set of samples in the corpus into subsets in one class or another based upon the differences in the entropy. The attribute with the highest normalized information gain is chosen to make the decision. The algorithm continues the tree on the smaller subsets after the node. In a non-limiting example, attributes are selected in this manner until a model is created that represents a most important amount (exemplarily 5%) of the information in the customer service interaction data.

Once the attributes have been identified at 20, the attributes may be represented as a N-dimensional vector where N is the number of attributes.

At 22 the corpus 18 is applied to the attribute vector in order to derive natural distributions for particular values (or value ranges or bins) for each attribute occurring in the corpus. For the derivation of such distributions, the attribute values may be represented as a series of value ranges or bins. Alpha-numeric values may be represented by a text string with suitable compensation for transcription errors or synonym use. The identified attributes and the natural distributions of these attributes found in the corpus are combined at 24 to provide probability of the occurrence of particular attribute values within the natural occurrence of the corpus. These natural distributions for the attribute values are used to identify anomaly in new customer service interactions.

A new customer service interaction 26 is received and exemplarily translated through speech-to-text techniques and technology 28. While the analysis of this customer service interaction at 26 for anomaly detection will be disclosed in greater detail herein, it is to be recognized that the customer service interaction data may also be stored at 16 and/or incorporated into the corpus 18 in the manners as will be described in greater detail herein in order for the system to learn or automatedly update to reflect new customer service interaction data as it is acquired.

As the new customer service interaction data is analyzed, the attribute value probabilities at 24 are applied to the new customer service interaction data in order to calculate an error value representative of the attribute value as occurred in the new customer service interaction data compared to the natural distribution of the attribute provided at 24. This error calculation is compared to a predetermined threshold 32. The predetermined threshold may be derived or selected through statistical analysis of the anomalies detected in accordance with the process with an additional factor in order to adjust the sensitivity of the anomaly detection either in the direction of inclusive detection of anomalies or in order to reduce false positives in identified anomalies.

Based upon the comparison of the calculated error to the predetermined threshold at 32 if the error is below the predetermined threshold then the customer service interaction is identified to be normal at 34. On the other hand, if the calculated error is above the predetermined threshold at 32, then the customer service interaction, is flagged as an anomaly at 36.

Customer service interactions identified as anomalies are then evaluated at 38 either by manual review of further data analysis in order to identify whether the customer service interaction anomaly is due to an internal or algorithmic error, such as, but not limited to a transcription error in the speech-to-text conversion at 40. Alternatively, the anomaly may be evaluated as a true anomaly 42 wherein the anomaly may be further monitored for future occurrences such as to determine whether or not the anomaly was simply a rare event or was a leading case of a new emerging trend in customer service interaction.

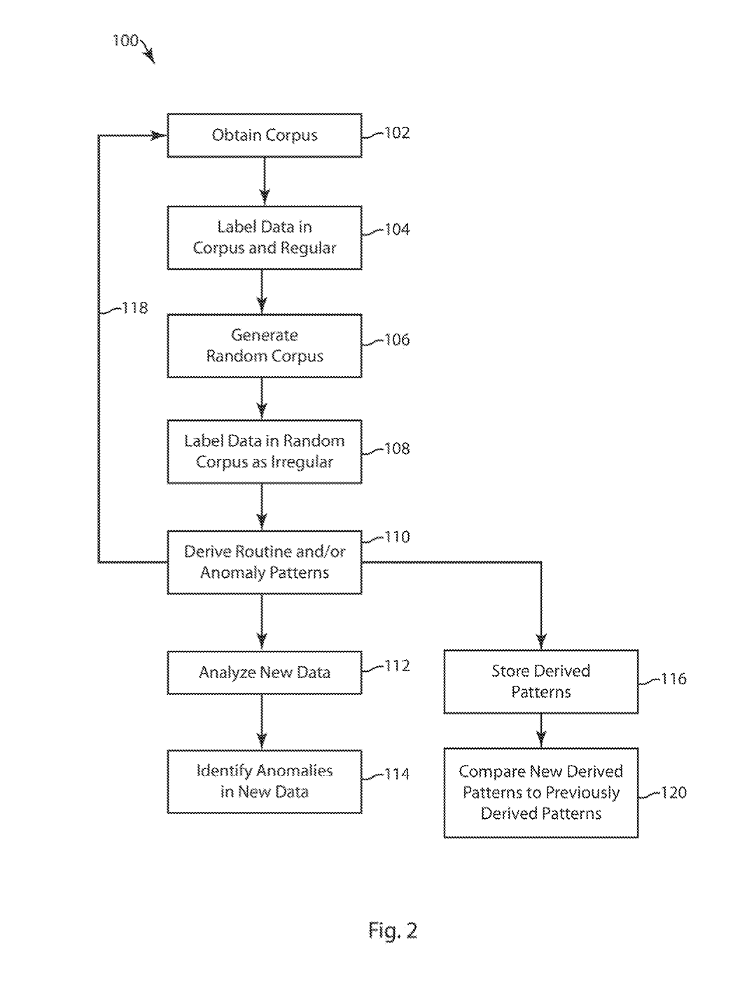

FIG. 2 is a flow chart that depicts an exemplary embodiment of a method of anomaly detection 100. The method 10 represents an exemplary more detailed embodiment of the method 300 described above. The method 100 begins by obtaining a corpus of a large data set. A non-limiting example of such a large data set would be one million rows of data where each row of data includes data values for a plurality of attributes x₁-x_{N} where N may be a large number in and of itself. in non-limiting examples, N may be 100, 1000 or more. At 104 the data in the corpus is labeled as regular for the purposes of deriving anomaly patterns. Next at 106 a random corpus with the same number of attributes x₁ is generated with each attribute value generated independently across the range of attribute values. In a non-limiting embodiment, the generated random corpus at 106 is smaller than the corpus obtained at 102, exemplarily 500,000 rows. At 108 the data in the random corpus is labeled as irregular.

At 110 routine and/or anomaly patterns are derived. In a non-limiting example of the derivation of the routine and/or anomaly pattern, the corpus is assumed to be a data set where each row has values for each of xᵢ attributes: {x_{i,}}₁=1^{N} p′(x,y) where p′(x,y) is an unknown joint natural probability function and p′(xⱼ) is the natural probability of x={x₁, . . . ,x_{N}} are the attributes and y identifies if the row represents a normal occurrence or an anomaly.

With this data set, F(x)=ŷ is a set of algorithms such that L(y,F(x)) is the loss function (for example: e=δ(y−F(x))). A model can then be defined as F*(x)=argmin_{F(x)}{L(y,F(X))} and p(xᵢ) is the empirical distribution of xᵢ as derived from the actual data of the corpus.

Thus, F(x) may be exemplarily represented as a decision tree which exemplarily may be based on minimum information gain criteria, with symmetric δ cost function for errors. The routine and/or anomaly patterns derived at 110 are applied to a new data vector to analyze the new data at 112. From the analysis conducted at 112, anomalies occurring in the new data are identified at 114. The new data vector may be identified as being an anomaly exemplarily if a derived anomaly pattern from 110 is identified in the new data. Alternatively the new data vector may be identified as being an anomaly if no routine patterns from 110 are identified in the new data vector. In addition to the analysis of a new set of data values, the routine patterns and/or anomaly patterns derived at 110 may be stored at 116 for later retrieval and/or use. As represented by arrow 118, embodiments of the method 100 may routinely repeat steps 102-140 in order to derive updated routine patterns and/or anomaly patterns which may change based upon updated data in the corpus at 102.

As a non-limiting example of such an updating loop, new routine and/or anomaly patterns may be derived in a weekly or other regular or semi-regular basis in order to incorporate new data obtained over that time period. In such embodiments, at 120 the new derived patterns can be compared to previously derived patterns in order to evaluate changes in the routine and/or anomaly patterns progressively over time periods such changes in the derived routine and/or anomaly patterns may reflect the emergence of a new topic or trend as an attribute value moves from being a rare occurrence or anomaly to a common or routine occurrence as just occur in the new data. Such a shift may exemplarily represent a customer response to new products or features, or a change in customer sentiment or expectations.

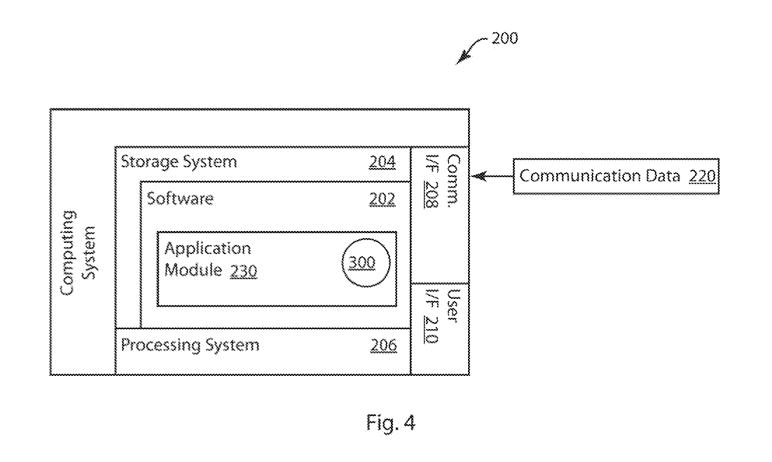

FIG. 4 is a system diagram of an exemplary embodiment of a system 200 for anomaly detection. The system 200 is generally a computing system that includes a processing system 206, storage system 204, software 202, communication interface 208 and a user interface 210. The processing system 206 loads and executes software 202 from the storage system 204, including a software module 230. When executed by the computing system 200, software module 230 directs the processing system 206 to operate as described in herein in further detail in accordance with the method 200 and more specifically embodiment, exemplarily disclosed in connection with process 10 or method 100 as set forth in FIGS. 1 and 2.

Although the computing system 200 as depicted in FIG. 4 includes one software module in the present example, it should be understood that one or more modules could provide the same operation. Similarly, while the description as provided herein refers to a computing system 200 and a processing system 206, it is to be recognized that implementations of such systems can be performed using one or more processors, which may be communicatively connected, and such implementations are considered to be within the scope of the description.

The processing system 20 can include a microprocessor and other circuitry that retrieves and executes software 202 from storage system 204. Processing system 206 can be implemented within a single processing device but can also be distributed across multiple processing devices or sub-systems that cooperate in executing program instructions. Examples of processing system 206 include general purpose central processing units, applications specific processors, and logic devices, as well as any other type of processing device, combinations of processing devices, or variations thereof.

The storage system 204 can include any storage media readable by processing system 206, and capable of storing software 202. The storage system 204 can include volatile and non-volatile, removable and non-removable media implemented in any method or technology for storage of information, such as computer readable instructions, data structures, program modules, or other data. Storage system 204 can be implemented as a single storage device but may also be implemented across multiple storage devices or sub-systems. Storage system 204 can further include additional elements, such a controller capable, of communicating with the processing system 206.

Examples of storage media include random access memory, read only memory, magnetic discs, optical discs, flash memory, virtual memory, and non-virtual memory, magnetic sets, magnetic tape, magnetic disc storage or other magnetic storage devices, or any other medium which can be used to store the desired information and that may be accessed by an instruction execution system, as well as any combination or variation thereof, or any other type of storage medium. In some implementations, the storage media can be a non-transitory storage media. In some implementations, at least a portion of the storage media may be transitory.

User interface 210 can include a mouse, a keyboard, a voice input device, a touch input device for receiving a gesture from a user, a motion input device for detecting non-touch gestures and other motions by a user, and other comparable input devices and associated processing elements capable of receiving, user input from a user. In embodiments, the user interface 210 operates to present and/or to receive information to/from a user of the computing system. Output devices such as a video display or graphical display can display an interface further associated with embodiments of the system and method as disclosed. herein. Speakers, printers, haptic devices and other types of output devices may also be included in the user interface 210.

As described in further detail herein, the computing system 200 receives interaction data 220 at the communication interface 208. In embodiments, the communication interface 208 operates to send and/or receive data from other devices to which the computing system 200 is communicatively connected. In an embodiment, the interaction data is audio data of an interpersonal communication which may exemplarily be between two speakers. In embodiments the audio data may be any of a variety of other audio records, including recorded or streaming audio data of multiple speakers, a single speaker, or an automated or recorded auditory message. In an embodiment, the interaction data is a transcription of interpersonal communication. The transcription may be generated by transcribing audio data. In an embodiment, the transcription is exemplarily achieved using, a large vocabulary continuous speech recognition (LVCSR) or other transcription technique. It is understood that any audio data may also undergo various forms of pre-processing prior to LVCSR transcription. Such preprocessing may include segmentation, exemplarily with a voice activity detector (VAD) in order to segment the audio data into a series of utterances, which are segments of audio data that are likely to be speech separated by segments of audio data that are likely to be non-speech segments.

The functional block diagrams, operational sequences, and flow diagrams provided in the Figures are representative of exemplary architectures, environments, and methodologies for performing novel aspects of the disclosure. While, for purposes of simplicity of explanation, the methodologies included herein may be in the form of a functional diagram, operational sequence, or flow diagram, and may be described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology can alternatively be represented as a series of interrelated states or events, such as in a state diagram. Moreover, not all acts illustrated in a methodology may be required for a novel implementation.

This written description uses examples to disclose the invention, including the best mode, and also to enable any person skilled in the art, to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A method of automated anomaly detection, the method comprising:
obtaining a corpus of interaction data at a computer readable medium;
identifying, with a processor, regular interaction data from the corpus;
receiving new interaction data at the processor;
comparing the new interaction data to the identified regular interaction data with the processor; and
identifying anomalies in the new interaction data with the processor.

2. The method of claim 1, wherein the interaction data is customer service interaction data.

3. The method of claim 2, wherein the customer service interaction data comprises a plurality of data attributes, each data attribute having an attribute value from a range of attribute values.

4. The method of claim 3, wherein the corpus comprises a plurality of transcriptions of customer service interactions.

5. The method of claim 3, wherein identifying the regular interaction data further comprises:
identifying a plurality of data attributes in the corpus; and
calculating a probability for each identified data attribute to occur in the interaction data of the corpus.

6. The method of claim 5, wherein the plurality of data attributes in the corpus are identified using a minimum information gain criteria.

7. The method of claim 5, wherein the probability for each identified data attribute is a distribution of the attribute values for that data attribute.

8. The method of claim 7, wherein comparing the new interaction data to the identified regular interaction data further comprises:
identifying an attribute value from the new interaction data for each of the plurality of data attributes;
comparing each identified attribute value from the new interaction data to the distribution of the attribute values for that data attribute.

9. The method of claim 3, further comprising;
evaluating each of the identified anomalies; and
categorizing each identified anomaly as either a true anomaly or an internal error.

10. The method of claim 3, wherein identifying the regular interaction data further comprises:
selecting subset of the corpus and labeling the selected subset as regular interaction data;
generating a random corpus of interaction data and labeling the interaction data of the random corpus as irregular;
analyzing the selected subset of the corpus and the random corpus to identify at least one regular interaction data pattern;

11. The method of claim 10, wherein identifying the regular interaction data further comprises identifying at least one anomaly pattern from the analysis of the selected subset of the corpus and the random corpus.

12. The method of claim 11, further comprising storing the identified at least one anomaly pattern for later application to new interaction data.

13. The method of claim 11, wherein identifying anomalies in the new interaction data with the processor further comprises:
applying, the identified at least one regular interaction data pattern and at least one anomaly pattern to the new interaction data;
determining if the new interaction data better fits the at least one regular interaction data pattern or the at least one anomaly pattern.

14. A method of automated anomaly detection, the method comprising:
obtaining a corpus of interaction data at a computer readable medium;
identifying, with a processor, regular interaction data from the corpus by identifying a plurality of attributes in the corpus of interaction data and an associated distribution of values for each of the identified plurality of attributes;
receiving, new interaction data at the processor;
identifying the plurality of attributes in the new interaction data and values for each of the identified attributes;
comparing the attribute values from the new interaction data to the associated distribution of values for each of the plurality of attributes; and
based upon the comparison, identifying anomalies in the new interaction data with processor.

15. The method of claim 14, further comprising:
calculating an error between the attribute values from the new interaction data to the associated distribution of values for each of the plurality of attributes;
comparing the calculated errors to a predetermined threshold to identify if an attribute value is an anomaly.

16. The method of claim 15, wherein if the attribute value is an anomaly, evaluating the attribute values to determine if the anomaly is an internal error or a true anomaly.

17. The method of claim 14, wherein the plurality of data attributes in the corpus are identified using a minimum information gain criteria.

18. A method of automated anomaly detection, the method comprising:
obtaining a corpus of interaction data, the interaction data comprising a plurality of attribute values at a computer readable medium;
identifying, with a processor, regular interaction data from the corpus by taking a subset of the corpus and labeling the attribute values of the subset as regular interaction data;
generating a random corpus comprising a plurality of attribute random values, and labeling the plurality of attribute random values as irregular interaction data;
deriving at least one regular attribute pattern and at least one anomaly attribute pattern from the regular interaction data and the irregular interaction data
receiving new interaction data at the processor;
comparing the new interaction data to the at least one regular attribute pattern and at least one anomaly attribute pattern; and
identifying anomalies in the new interaction data with the processor.

19. The method of claim 18, further comprising storing the derived at least one regular attribute pattern and at least one anomaly attribute pattern.

20. The method of claim 18, wherein the at least one regular attribute pattern and at least one anomaly attribute pattern are decision trees based upon minimum information gain criteria.
